(19) United States
(12) Patent Application Publication
(10) Pub. No.: US 2013/0128954 A1
(43) Pub. Date: May 23, 2013

(54) ENCODING METHOD AND APPARATUS

(71) Applicant: Electronics and Telecommunications Research, Daejeon (KR)

(72) Inventors: Jong Ho KIM, Daejeon-si (KR); Se Yoon JEONG, Daejeon-si (KR); Suk Hee CHO, Daejeon-si (KR); Jin Soo CHOI, Daejeon-si (KR); Jin Woong KIM, Daejeon-si (KR)

(73) Assignee: Electronics and Telecommunications Research Institute, Daejeon (KR)

(21) Appl. No.: 13/678,428

(22) Filed: Nov. 15, 2012

(30) Foreign Application Priority Data
Nov. 21, 2011 (KR) 10-2011-0121379

(51) Int. Cl. H04N 7/26

(52) U.S. Cl. CPC H04N 19/00266
USPC 375/240.02

(57) ABSTRACT

The encoding method includes: an information collecting step of collecting at least any one of coding information of a reference unit, which includes at least one of a first reference unit adjacent to a current coding unit or a current prediction unit, a second reference unit present at a position corresponding to the current coding unit or the current prediction unit in a reference image, and a third reference unit adjacent to the second reference unit, or coding information of a higher unit, which includes the current coding unit or the current prediction unit and has a size greater than that of the current prediction unit; and predictive coding performing step of performing predictive coding by determining whether to omit a predictive coding process with respect to the current coding unit or the current prediction unit by using the collected coding information.

### CROSS-REFERENCE TO RELATED APPLICATIONS

This application claims the benefit of priority of Korean Patent Application No. 10-2011-0121379 filed on Nov. 21, 2011, all of which are incorporated by reference in their entirety herein.

### BACKGROUND OF THE INVENTION

1. Field of the Invention

The present invention relates to an encoding method and apparatus and, more particularly, to an encoding method and apparatus capable of effectively reducing calculation complex.

2. Related Art

In an image encoding technique, various schemes using prediction picture for image encoding have been studied. MPEG (Moving Picture Experts Group) and VCEG (Video Coding Experts Group) have developed excellent video compression technique superior to existing MPEG-4 Part 2 and H.263 standard. The novel standard, dubbed H.264/AVC (Advanced Video Coding), released as MPEG-4 Part 10 AVC and ITU-T Recommendation H.264 jointly.

H.264/AVC (referred to as ‘H.264’, hereinafter) uses a spatial predictive encoding method different from conventional video coding international standards such as MPEG-1, MPEG-2, MPEG-4 Part 2 Visual, and the like. The related art method uses ‘intra prediction’ with respect to a coefficient value converted in a DCT transform domain to thus increase encoding efficiency to result in a generation of degradation of subjective picture quality at a low band transfer bit rate, but H.264 adopts a spatial intra prediction encoding method in a spatial domain rather than in a transform domain.

### SUMMARY OF THE INVENTION

The present invention provides an encoding method and apparatus capable of reducing complexity based on a scheme of determining whether to perform a predictive coding process with respect to a unit desired to be currently encoded through a reference coding unit by using statistical characteristics and encoding information of images and determining whether to perform the predictive coding process on a coding unit having a smaller size through a coding unit having a greater size.

In an aspect, an encoding method is provided. The encoding method includes: an information collecting step of collecting at least any one of coding information of a reference unit, which includes at least one of a first reference unit that is positioned to be adjacent to a current coding unit or a current prediction unit and previously coded, a second reference unit present at a position corresponding to the current coding unit or the current prediction unit in a reference image, and a third reference unit positioned to be adjacent to the second reference unit, or coding information of a higher unit, which includes the current coding unit or the current prediction unit and has a size greater than that of the current coding unit or the current prediction unit; and a predictive coding performing step of performing predictive coding by determining whether to omit a predictive coding process with respect to the current coding unit or the current prediction unit by using the collected coding information.

The information collecting step may include a step of collecting at least any one of motion vector information of the reference unit or the higher unit, optimal prediction mode information, division information, conversion coefficient information, and encoding cost information.

The predictive coding performing step may include: encoding the current coding unit or the current prediction unit in a skip mode and omitting a remaining predictive coding process with respect to the current coding unit or the current prediction unit, either when a motion vector is smaller than a particular value based on at least any one motion vector information of the reference unit and the higher unit, or when a motion vector of the higher unit is equal to a predicted motion vector obtained from the reference unit.

The predictive coding performing step may include: encoding the current coding unit or the current prediction unit in the skip mode or a merge mode and omitting a remaining predictive coding process with respect to the current coding unit or the current prediction unit, when, based on at least any one of optimal prediction mode information of the reference unit and the higher unit, the optimal prediction mode information is any one of the skip mode and the merge mode.

The predictive coding performing step may include: encoding the current coding unit or the current prediction unit in the skip mode without dividing the current coding unit or the current prediction unit, and omitting a remaining predictive coding process with respect to the current coding unit or the current prediction unit, when, based on division information of the reference unit, the reference unit or the current prediction unit has not been divided or the size of the reference unit is greater than that of the current coding unit.

The predictive coding performing step may include: calculating encoding cost of the current coding unit or the current prediction unit; and comparing the calculated encoding cost with any one of an average encoding cost of reference units encoded in any one of the skip mode and the merge mode and encoding cost of a higher unit encoded in any one of the skip mode and the merge mode, and encoding the current coding unit or the current prediction unit in the skip mode or the merge mode and omitting a remaining predictive coding process with respect to the current coding unit or the current prediction unit when the calculated encoding cost is smaller.

The predictive coding performing step may include: when conversion coefficients of any one of the reference units and the higher units are entirely or mostly 0, encoding the current coding unit or the current prediction unit in the skip mode and omitting a remaining predictive coding process with respect to the current coding unit or the current prediction unit.

The particular value may include any one of 0, 1, and an average value of motion vector values of reference units encoded in the skip mode.

The encoding cost may include any one of rate-distortion cost, a sum of absolute difference (SAD) value, a sum of squared difference (SSD) value, and a sum of absolute transformed difference (SATD) value.

The conversion coefficient may include at least one of coded block pattern information and coded block flag information.

In another aspect, an encoding apparatus is provided. The encoding apparatus includes: an information collecting unit configured to collect at least any one of coding information of a reference unit, which includes at least one of a first reference unit that is positioned to be adjacent to a current coding unit or a current prediction unit and previously coded, a second reference unit present at a position corresponding to the current coding unit or the current prediction unit in a reference image, and a third reference unit positioned to be adjacent to the second reference unit, or coding information of a higher unit, which includes the current coding unit or the current prediction unit and has a size greater than that of the current coding unit or the current prediction unit; and a predictive coding unit configured to perform predictive coding by determining whether to omit a predictive coding process with respect to the current coding unit or the current prediction unit by using the collected coding information.

The information collecting unit may collect at least any one of motion vector information of the reference unit or the higher unit, optimal prediction mode information, division information, conversion coefficient information, and encoding cost information.

Either when a motion vector is smaller than a particular value based on at least any one motion vector information of the reference unit and the higher unit, or when a motion vector of the higher unit is equal to a predicted motion vector obtained from the reference unit, the predictive coding unit may encode the current coding unit or the current prediction unit in a skip mode and omit a remaining predictive coding process with respect to the current coding unit or the current prediction unit.

Based on at least any one of optimal prediction mode information of the reference unit and the higher unit, when the optimal prediction mode information is any one of the skip mode and the merge mode, the predictive coding unit may encode the current coding unit or the current prediction unit in the skip mode or the merge mode and omit a remaining predictive coding process with respect to the current coding unit or the current prediction unit.

Based on division information of the reference unit, when the reference unit or the current prediction unit has not been divided or the size of the reference unit is greater than that of the current coding unit, the predictive coding unit may encode the current coding unit or the current prediction unit in the skip mode without dividing the current coding unit or the current prediction unit, and omit a remaining predictive coding process with respect to the current coding unit or the current prediction unit.

The predictive coding unit may include: a cost calculation unit configured to calculate encoding cost of the current coding unit or the current prediction unit; and a predictive encoding process omitting unit configured to compare the calculated encoding cost with any one of an average encoding cost of reference units encoded in any one of the skip mode and the merge mode and encoding cost of a higher unit encoded in any one of the skip mode and the merge mode, and encode the current coding unit or the current prediction unit in the skip mode or the merge mode and omit a remaining predictive coding process with respect to the current coding unit or the current prediction unit when the calculated encoding cost is smaller.

When conversion coefficients of any one of the reference units and the higher units are entirely or mostly 0, the predictive coding unit may encode the current coding unit or the current prediction unit in the skip mode and omit a remaining predictive coding process with respect to the current coding unit or the current prediction unit.

The particular value may include any one of 0, 1, and an average value of motion vector values of reference units encoded in the skip mode.

The encoding cost may include any one of rate-distortion cost, a sum of absolute difference (SAD) value, a sum of squared difference (SSD) value, and a sum of absolute transformed difference (SATD) value.

The conversion coefficient may include at least one of coded block pattern information and coded block flag information.

### BRIEF DESCRIPTION OF THE DRAWINGS

FIG. 1 is a diagram illustrating encoding using coding units having various sizes.

FIG. 2 is a diagram illustrating calculation of sub-sampled SAD.

FIG. 3 is a diagram illustrating generation of prediction block while moving both two blocks in images L0 and L1 in bi-directional prediction.

FIG. 4 is a diagram illustrating generation of prediction block while moving only a unit of the image L1 with an optimal unit in the image L0 in bi-directional prediction.

FIG. 5 is a view illustrating a process of an encoding method according to a first embodiment of the present invention.

FIG. 6 is a detailed view illustrating a process of utilizing motion vector information in an encoding method according to a second embodiment of the present invention.

FIG. 7 is a detailed view illustrating a case of utilizing an optimal prediction mode information in an encoding method according to a third embodiment of the present invention.

FIG. 8 is a detailed view illustrating a case of utilizing division information of a reference unit in an encoding method according to a fourth embodiment of the present invention.

FIG. 9 is a detailed view illustrating a case of utilizing encoding cost information in an encoding method according to a fifth embodiment of the present invention.

FIG. 10 is a detailed view illustrating a case of utilizing a conversion coefficient information in an encoding method according to a sixth embodiment of the present invention.

FIG. 11 is a schematic block diagram of an encoding apparatus according to an embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail.

However, it is to be understood that the present invention is not limited to the specific exemplary embodiments, but includes all modifications, equivalents, and substitutions included in the spirit and the scope of the present invention.

Further, in describing exemplary embodiments of the present invention, well-known functions or constructions will not be described in detail since they may unnecessarily obscure the understanding of the present invention.

Terms used in the specification, ‘first’, ‘second’, etc., may be used to describe various components, but the components are not to be construed as being limited to the terms. That is, the terms are used to distinguish one component from another component. Therefore, the first component may be referred to as the second component, and the second component may be referred to as the first component. The term ‘and/or’ includes a combination of a plurality of items or any one of a plurality of terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

In addition, components described in exemplary embodiments of the present invention are independently shown only in order to indicate that they perform different characteristic functions. Therefore, the components that are independently shown do not mean that each of the components may not be implemented as one hardware or software. That is, each of the components is divided for convenience of explanation, a plurality of components may be combined with each other to thereby be operated as one component or one component may be divided into a plurality components to thereby be operated as the plurality of components, which are included in the scope of the present invention as long as it departs from essential characteristics of the present invention.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

For predictive coding, a scheme of performing coding on every size of coding units from the largest coding unit (LCU) or the smallest coding unit (SCU) and selecting a unit having the lowest rate-distortion costs has been used. However, the related art has considerably high complexity because rate-distortion costs calculation should be performed on every unit. Also, a fast coding scheme included in the related art encoder uses parameters using fixed values, rather than setting parameters reflecting the characteristics of images, having low efficiency.

In order to solve the problem, the present invention proposes an encoding method and apparatus for determining whether to omit an encoding process with respect to a current coding unit or a current prediction unit based on coding information of a reference unit or a higher unit.

Throughout the present disclosure, a unit refers to a block unit divided to perform encoding. Unit may be used together with terms such as block, area, or the like, according to circumstances. A coding unit refers to a unit divided to have a square shape in performing coding and a maximum unit that is able to perform conversion of a single size. Namely, a single coding unit, as a basic unit for processing an image, may be divided into several coding units.

A prediction unit is a smaller unit obtained by dividing a coding unit, and various prediction and compensation is performed by prediction units. The prediction unit is a basic unit for performing prediction, and the form of a prediction unit differs in inter-prediction and intra-prediction. Predictive coding refers to a coding process including a motion prediction/compensation, intra-/inter-prediction coding.

Also, in prediction coding of the present disclosure, a prediction mode may be used in order to reduce transmission information. The prediction mode includes three types of prediction modes; 1) a merge mode, 2) a skip mode, and 3) a direct mode.

1) In the merge mode, a single coding unit may be merged with a different vertical or horizontal adjacent unit. An encoder encodes information indicating whether or not a single coding unit has been merged with a different adjacent unit and information indicating with which unit the single coding unit has been merged. A decoder obtains prediction information of a current coding unit from inter-prediction information of an adjacent reference unit. Here, in order to determine whether or not the corresponding unit has been merged, the information indicating whether or not the single coding unit has been merged with a different adjacent unit and information indicating with which unit the single coding unit has been merged may be used. A candidate unit that can be merged with the current coding unit may be a unit adjacent to the current coding unit. Preferably, the candidate unit may be a unit adjacent a left upper end of the current coding unit, a unit adjacent to a right upper end of the current coding unit, and a unit adjacent to a left lower end of the current coding unit.

2) The skip mode refers to a scheme in which information related to a syntax other than motion vector information with respect to a corresponding unit is not transmitted. Namely, in the skip mode, an encoder encodes only motion vector information of a current coding unit, and omits a remaining coding process. In order for a decoder to obtain inter-prediction information of the current coding unit in the skip mode, the decoder may use the same method as that used in the merge mode. Namely, inter-prediction information in any designated single unit among candidate units in the merge mode may be used as inter-prediction information of the current coding unit as it is.

3) The direct mode refers to a scheme in which even motion vector information itself is not transmitted. When a reference unit is outside an intra-mode or an image region, a decoder generates predictive image by setting motion information as ‘0’ and adds it to a received residual image block to generate a decoded image block.

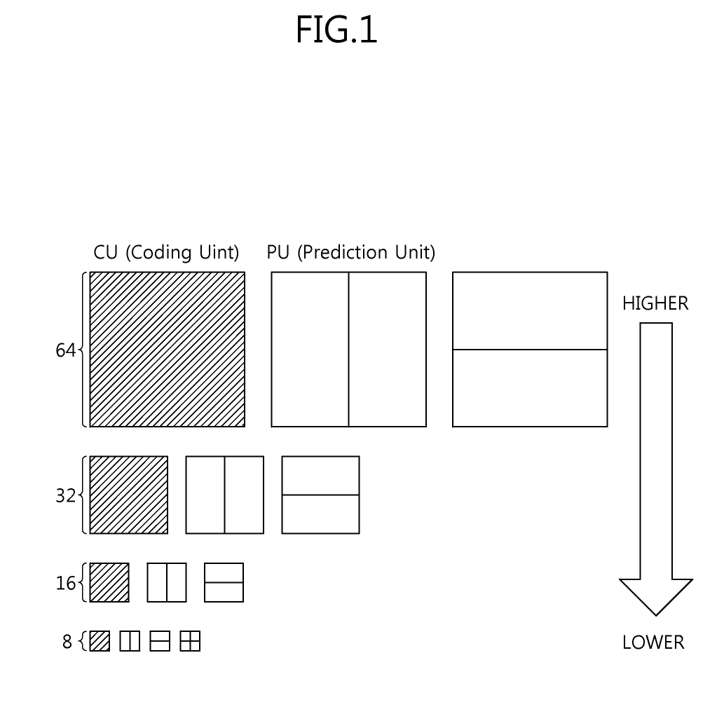

FIG. 1 is a diagram illustrating encoding using coding units having various sizes. As shown in FIG. 1, first, an input image is divided into coding units having various sizes, and the coding units are divided into prediction units. FIG. 1 shows a case in which a size of one side of a maximum coding unit is 64 and a maximum layer level or layer depth is 4. The coding units may be circulatively divided until when a layer level or a layer depth thereof reaches a maximum allowable layer level or layer depth (which is 4 in case of FIG. 1). When the layer level or layer depth of the coding units are equal to the maximum allowable layer level or layer depth, the coding units are not divided any further.

And, a motion prediction and compensation process is performed on all of the divided coding units and prediction units. A unit having the smallest having in terms of rate-distortion costs among the respective coding units and prediction units is finally selected, based on which coding is performed. The size of the coding units may extend to be larger or smaller, and the shapes of the prediction units may be variably changed.

A fast encoding decision (FEN) technique includes three methods.

1) First, there is a coding unit omitting technique. This technique refers to a method of determining whether to calculate a coding unit having a smaller size in a stage of coding unit having a greater size. In detail, when rate-distortion costs incurred when a current coding unit is encoded as an omission are smaller than a value obtained by multiplying average rate-distortion costs by 1.5 (weight) (i.e., rate-distortion costs*1.5) of coding units which were coded as omission beforehand, whether to calculate coding units may be determined through a scheme of not performing calculation on a current coding unit.

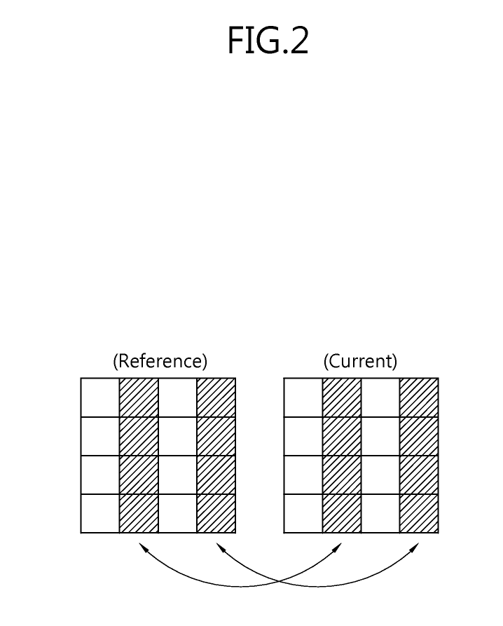

2) Second, there is a sub-sampled sum of absolute difference (SAD) calculation technique. FIG. 2 is a diagram illustrating calculation of sub-sampled SAD. An SAD is a value indicating a difference degree between two images, which is obtained by adding a different between corresponding pixel values in each image. The fast encoding decision technique employs a scheme of obtaining a difference between pixels at every two pixels or four pixels, as shown in FIG. 2, in calculating an SAD in a range higher than a particular search range, rather than obtaining a difference between all the pixel values.

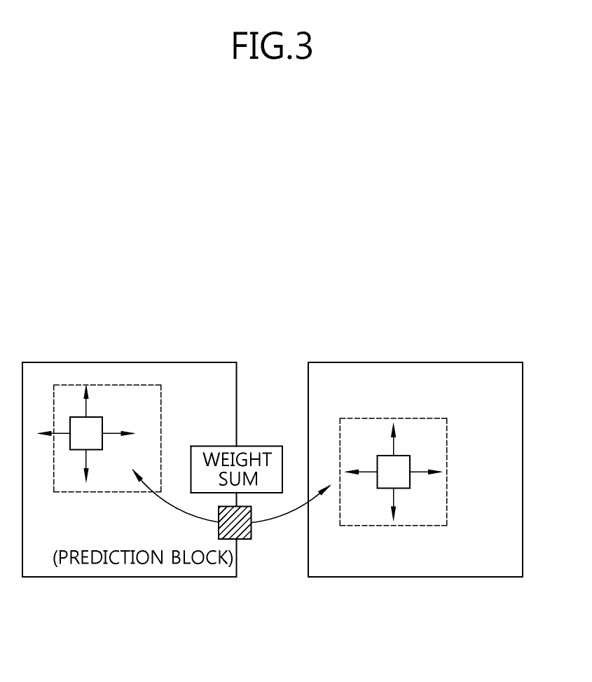

3) Third, there is a technique of using simplified bi-directional prediction. Bi-directional prediction refers to a technique of predicting the present in both directions of the past and the future. In this technique, in predicting a frame to be encoded, prediction is performed on a frame positioned ahead temporally and a frame positioned behind temporally in both directions. Here, L0 refers to a reference image for forward prediction, and L1 refers to a reference image for reverse prediction. FIG. 3 is a diagram illustrating generation of prediction block while moving both two blocks in images L0 and L1 in bi-directional prediction. Here, the dotted lines indicate a search range. In general, in the case of bi-directional prediction, a scheme of generating prediction blocks while moving both of two corresponding blocks in the images L0 and L1, calculating SAD values with an original image, and determining a prediction block having the smallest value is as a final prediction block as shown in FIG. 3 is used.

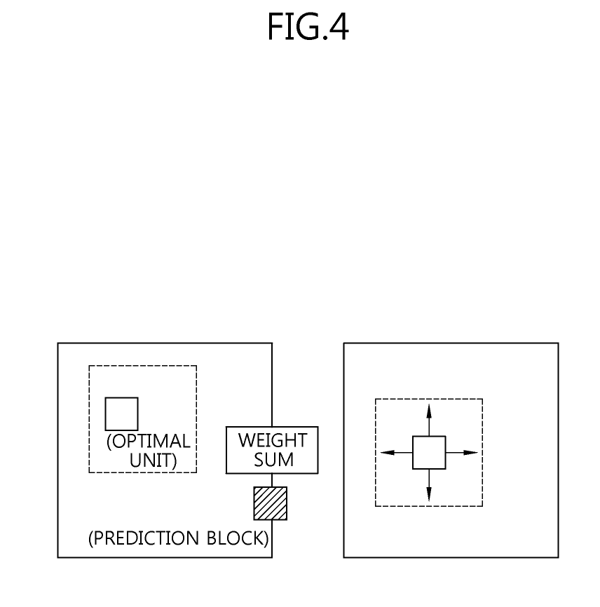

FIG. 4 is a diagram illustrating generation of prediction block while moving only a unit of the image L1 with an optimal unit in the image L0 in bi-directional prediction. As shown in FIG. 4, a scheme of generating a prediction block while moving only the unit of L1 with the previously obtained optimal unit in L0 of uni-directional prediction in actuality.

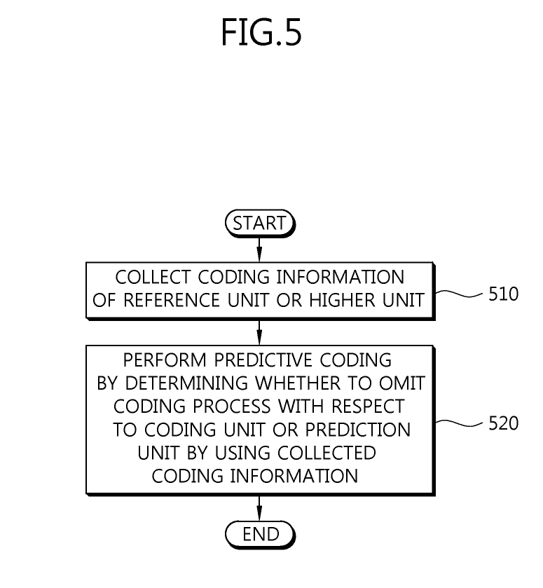

FIG. 5 is a view illustrating a process of an encoding method according to a first embodiment of the present invention. As shown in FIG. 5, an encoding method according to an embodiment of the present invention may include a step (510) of collecting encoding information of a reference unit or a higher unit and a step (520) of performing predictive coding by determining whether to omit an encoding process on a coding unit or a prediction unit by using the collected coding information. A reference unit according to an embodiment of the present invention may include at least any one of 1) a previously coded neighbor unit positioned to be adjacent to a current coding unit or a current prediction unit, 2) a unit present at a position corresponding to the current coding unit or the current prediction unit in a reference image, and 3) a unit positioned to be adjacent to a unit present at the corresponding position.

First, in the information collecting step (510), the encoding apparatus collects coding information from a reference unit or a higher unit of a unit currently desired to be encoded. The coding information of the reference unit includes motion vector information, optimal mode information (intra-mode/inter-mode), an optimal conversion depth of the reference unit, a division depth of a coding unit, coded block pattern/coded block flag information of the reference unit, and encoding cost information of the reference unit, but the present invention is not limited thereto. Also, the coding information may include conversion coefficient information. Encoding cost information refers to a value that may indicate a difference between images such as an SAD/SSD (Sum of Squared Difference)/SATD (Sum of Absolute Transformed Difference), rate-distortion cost, or the like. Also, coding information in a unit having a greater size is coding information generated after coding is first performed in the unit having the greater size, which includes motion vector information, optimal mode information (intra-mode/inter-mode), coded block pattern/coded block flag information, conversion coefficient information, and encoding cost information, but the present invention is not limited thereto.

In the predictive coding performing step (520), the encoding apparatus performs predictive coding on a current coding unit and a current prediction unit by using coding information collected in the information coding step (510). Since the current coding unit is highly likely to be encoded in a similar manner as the coding in the reference unit and higher unit, whether to omit predictive coding of the coding unit may be determined based on the coding information of the reference unit and the higher unit as mentioned above. Whether to omit predictive coding may be performed together with any one of the merge mode and the skip mode as mentioned above.

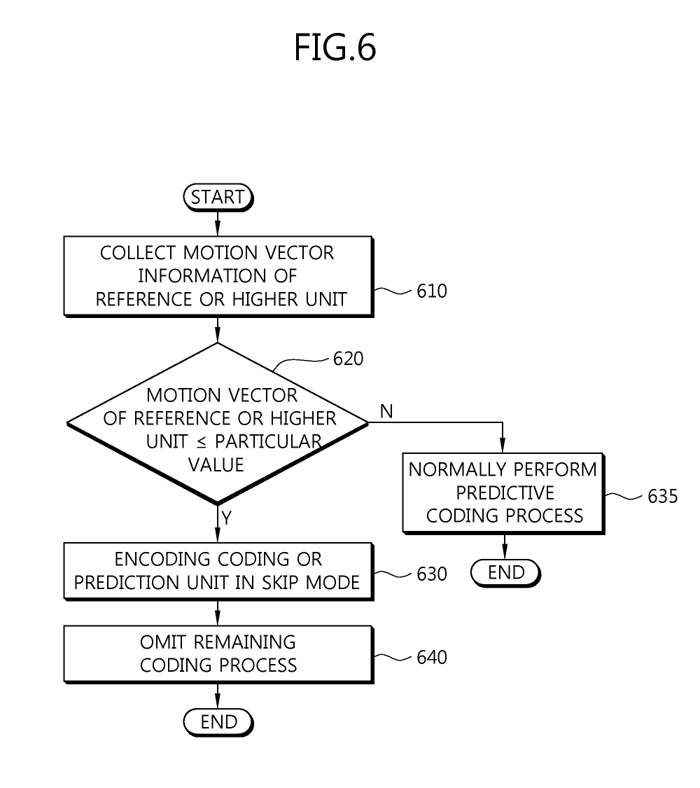

FIG. 6 is a detailed view illustrating a process of utilizing motion vector information in an encoding method according to a second embodiment of the present invention. As described above, whether to omit a process of predictive coding of a unit desired to be currently encoded may be determined by using motion vector information of the reference unit and the higher unit.

First, the encoding apparatus collects motion vector information of the reference or the higher unit (610). The collected motion vector of the reference or higher unit is compared with a particular value (620). When the collected motion vector of the reference or higher unit is equal to or smaller than a particular value, a current coding unit or a current prediction unit is coded in the skip mode (630), and a remaining predictive coding process may be omitted (640). However, when the collected motion vector of the reference or higher unit is greater than the particular value, since the motion vector information may be used as an important factor, so the predictive coding process is normally performed (635). Preferably, the particular value may be a value as small as 0 or 1. Also, the particular value may be an average of motion vector values of reference units of the unit which was already encoded in the skip mode beforehand.

In determining whether to omit the predictive coding process by using motion vector information, even when the motion vector of the higher unit is identical to the predicted motion vector obtained from the reference unit, the coding unit or the prediction unit is encoded in the skip mode and a remaining predictive coding process may be omitted.

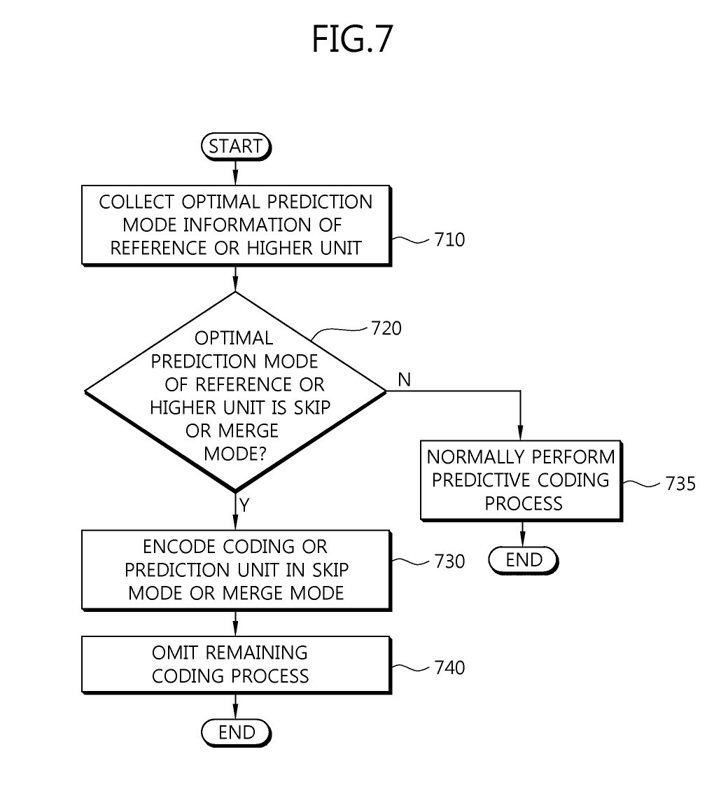

FIG. 7 is a detailed view illustrating a case of utilizing an optimal prediction mode information in an encoding method according to a third embodiment of the present invention. As described above, whether to omit a predictive coding process of a unit currently desired to be encoded may be determined by using prediction mode information of a reference unit and a higher unit. There is a considerably high possibility that an optimal prediction mode of the reference unit or the higher unit is identical to a prediction mode of a current coding unit. Thus, an optimal prediction mode of the current encoding unit may be estimated through the optimal prediction mode of the reference or higher unit, based on which whether to omit the predictive coding process may be determined.

First, the encoding apparatus collects optimal prediction mode information of a reference or higher unit (710). The encoding apparatus determines whether or not the collected optimal prediction mode of the reference or higher unit is a skip mode or merge mode (720). If the optimal prediction mode of the reference or higher unit is the skip mode or merge mode according to determination result, the current coding unit or the current prediction unit is highly likely to be in the skip mode or the merge mode, so the encoding apparatus encodes the current coding unit or the current prediction unit in the skip mode or the merge mode (730) and omit the remaining coding process (740). In detail, when the optimal prediction mode of the reference unit or the higher unit is the skip mode, the current coding unit or the current prediction unit is encoded in the skip mode, and when the optimal prediction mode of the reference unit or the higher unit is the merge mode, the current coding unit or the current prediction unit is encoded in the merge mode. However, when the optimal prediction mode of the reference unit or the higher unit is not the skip mode nor the merge mode, thee predictive coding process is normally performed, rather than being omitted (735).

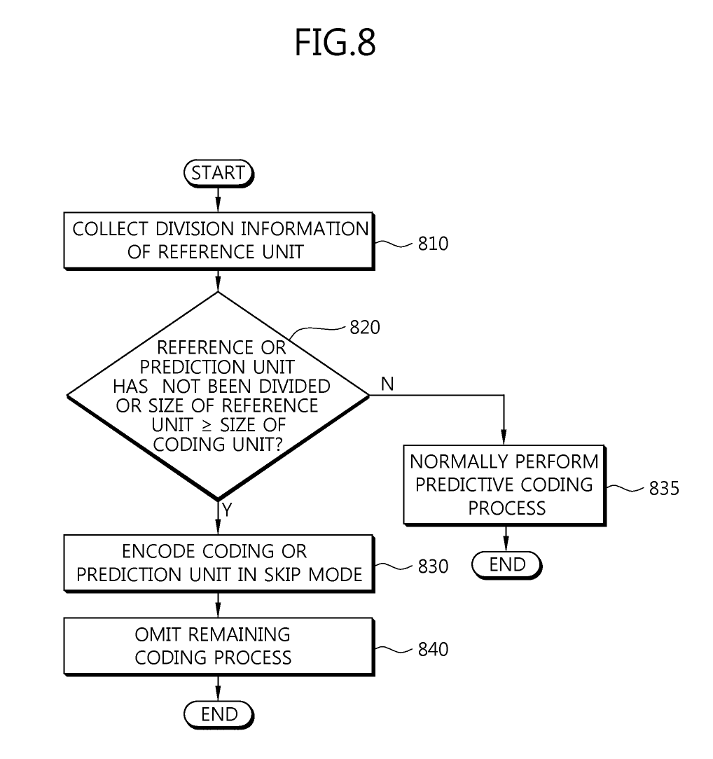

FIG. 8 is a detailed view illustrating a case of utilizing division information of a reference unit in an encoding method according to a fourth embodiment of the present invention. An optimal prediction mode of a unit desired to be currently encoded may be determined by using division information of a reference unit or a prediction unit, and whether to omit the remaining coding process may be determined.

First, the encoding apparatus collects division information of a reference or prediction unit (810). The encoding apparatus determines whether or not the reference unit or the prediction unit has not been divided or whether or not the size of the reference unit is equal to or greater than the size of the current coding unit, based on the collected division information of thee reference or prediction unit (820). When the reference unit or the prediction unit has not been divided or when the size of the reference unit is equal to or greater than the size of the current coding unit, there is a high possibility that the current coding unit will not be divided and will be encoded in the skip mode, so the encoding apparatus encodes the current coding unit in the skip mode and also encodes the current prediction unit in the skip mode (830). And, the encoding apparatus may omit the remaining coding process (840). If the reference unit or the prediction unit has not been divided or when the size of the reference unit is smaller than that of the coding unit, the predictive coding process may not be omitted and coding may be normally performed (835).

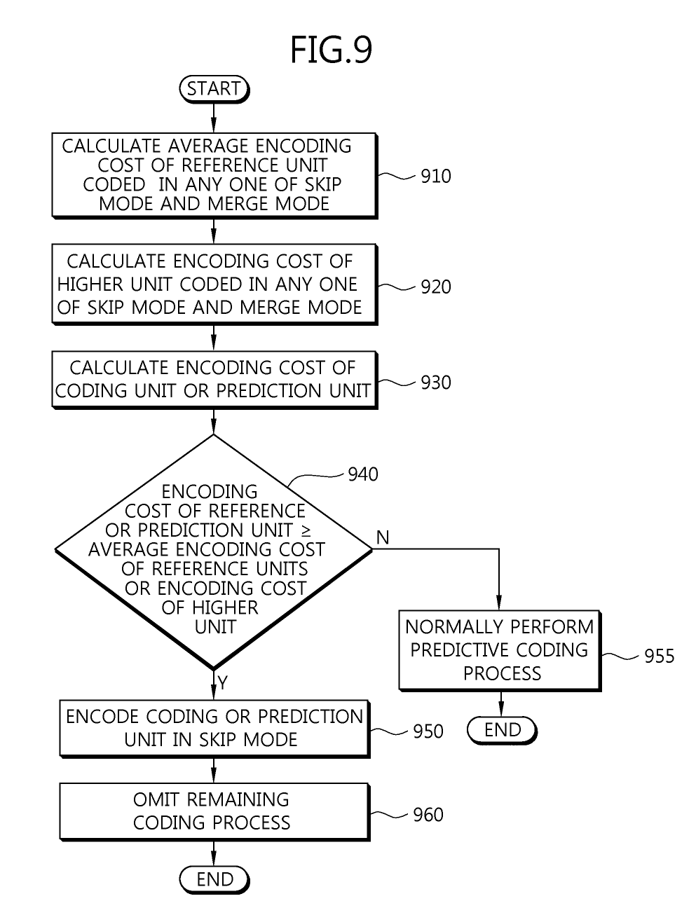

FIG. 9 is a detailed view illustrating a case of utilizing encoding cost information in an encoding method according to a fifth embodiment of the present invention. Whether to omit a predictive coding process of a unit currently desired to be encoded may be determined by using encoding cost information of a reference unit or a higher unit.

First, the encoding apparatus calculates an average encoding cost of reference units coded in any one of the skip mode and the merge mode (910). Since a plurality of reference units may exist, so preferably, average encoding cost thereof is calculated. Next, encoding cost of a unit having a greater size encoded in any one of the skip mode and the merge mode is calculated (920). And then, encoding costs of a coding unit or a prediction unit is calculated (930). In the case of calculation, preferably, it is assumed that the current coding unit or the current prediction unit has been encoded in any one of the skip mode and the merge mode. The calculated encoding cost of the current coding unit or the current prediction unit is compared with the average encoding cost of the reference units or encoding cost of the higher unit (940). When the calculated encoding cost of the current coding unit or the current prediction unit is smaller than the average encoding cost of the reference units or the encoding cost of the higher unit, there is a high possibility that the current coding unit or the current prediction unit will be encoded in the skip mode or the merge mode, so the current coding unit or the current prediction unit is encoded in the skip mode or the merge mode (950) and the remaining coding process may be omitted (960). When the calculated encoding cost of the current coding unit or the current prediction unit is greater than the average encoding cost of the reference units or the encoding cost of the higher unit, the coding process of the current coding unit or the current prediction unit cannot be omitted and the predictive coding process is normally performed (955).

According to another embodiment of the present invention, the coding unit is affected by the reference unit. Thus, when the encoding cost of the reference units is smaller than the average encoding cost of the units previously encoded in the skip mode or the merge mode, the current coding unit and the current prediction unit are highly likely to be encoded in the skip mode or the merge mode. Thus, in this case, the current coding unit or the current prediction unit is encoded in the skip mode and the remaining coding process may be omitted.

Also, according to another embodiment of the present invention, when the encoding costs increase toward units having a smaller size, the coding process with respect to the lower units may be omitted. For example, in case in which units are configured by four stages (first stage: single 64×64 unit˜fourth stage: sixteen 8×8 units), if encoding cost of the first stage is greater than that of the second stage, the coding process of the remaining third and fourth stages may be omitted. Alternatively, when the encoding cost of the first stage is greater than that of the second stage and the encoding cost of the second stage is greater than that of the third stage, namely, when the encoding costs decreases sequentially, the coding process of the fourth stage may be omitted.

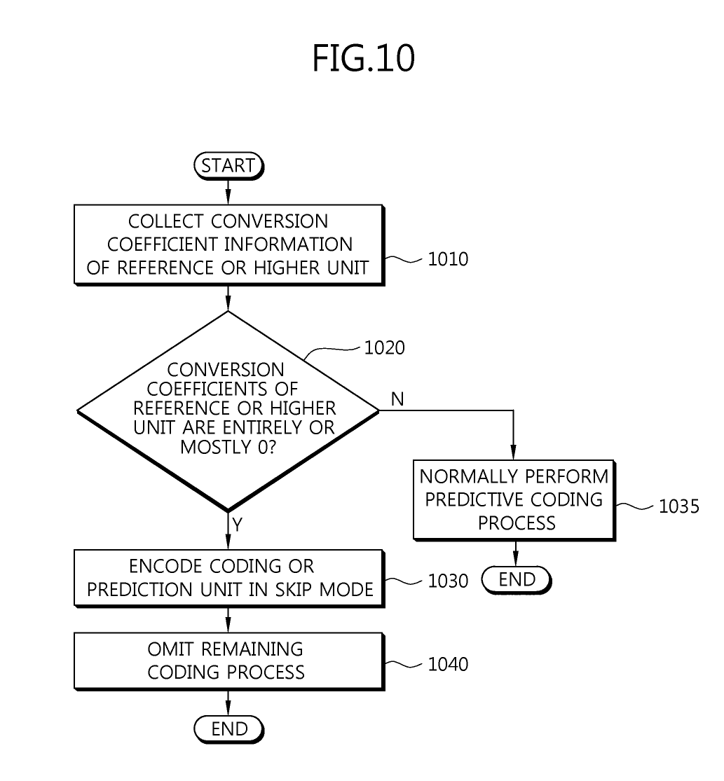

FIG. 10 is a detailed view illustrating a case of utilizing a conversion coefficient information in an encoding method according to a sixth embodiment of the present invention. An optimal prediction mode of a unit currently desired to be encoded may be determined by using conversion coefficient information of a reference unit or a prediction unit, and whether to omit the remaining coding process may be determined.

First, the encoding apparatus collects conversion coefficient information of a reference or higher unit (1010). Next, the encoding apparatus determines whether or not the collected conversion coefficients of the reference or higher units are entirely or mostly 0 (1020). When the collected conversion coefficients of the reference or higher units are entirely or mostly 0, there is a high possibility that the conversion coefficients of the coding unit and prediction unit are also entirely or mostly 0. Thus, in such a case, the encoding apparatus encodes the current coding unit or the current prediction unit in the skip mode (1030), and the remaining coding process is omitted (1040). When the collected conversion coefficients of the reference or higher units are not entirely nor mostly 0, the coding process with respect to the current coding unit or the current prediction unit should be normally performed (1035).

According to another embodiment of the present invention, coded block pattern/coded block flag information of a reference unit or a higher unit may be used in addition to the conversion coefficient information. In general, the coded block pattern is a coded block pattern information that may have values from 0 to 15, and the coded block flag may have a value of 0 or 1. When the coded block patterns/coded block flag values of the reference units or the higher units are entirely or mostly 0, the coding process of the coding unit or the prediction unit may be omitted.

The size of a weight used in the fast encoding decision (EFN) technique may be changed by using the encoding method according to the first to sixth embodiments of the present invention. For example, when the omission conditions in the first to sixth embodiments are met, the size of the weight in the EFN technique may be increased.

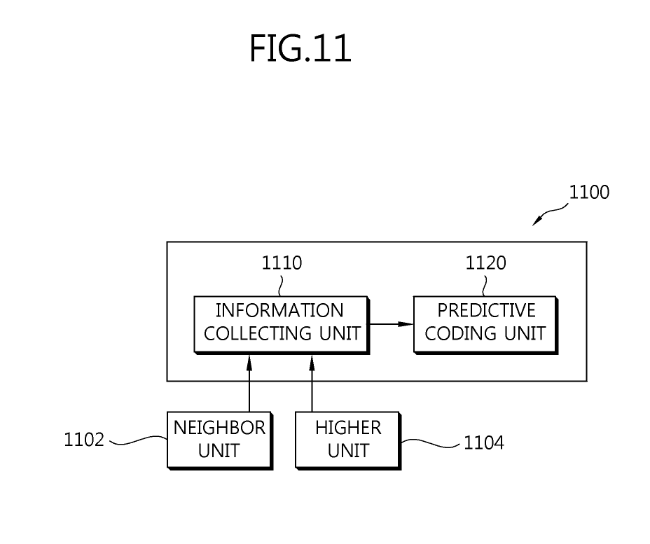

FIG. 11 is a schematic block diagram of an encoding apparatus 1100 according to an embodiment of the present invention. As shown in FIG. 11, the encoding apparatus 1100 according to an embodiment of the present invention may include an information collecting unit 1110 and a predictive coding unit 1120.

The information collecting unit 1110 collects coding information of reference units 1102 or a unit 1104 having a greater size. As described above, the reference unit 1102 is any one of a previously encoded unit positioned to be adjacent to a current coding unit or a current prediction unit, a unit present at a position corresponding to the current coding unit or the current prediction unit in a reference image, and a unit positioned to be adjacent to the unit present at the corresponding position, and the unit 1104 having a greater size indicates a unit having greater size than that of the current coding unit or the current prediction unit.

The predictive coding unit 1120 performs predictive coding by determining whether to omit a predictive coding process with respect to the current coding unit or the current prediction unit by using the coding information collected by the information collecting unit 1110.

In detail, the information collecting unit 1110 of the encoding apparatus 1100 may collect at least any one of motion vector information, optimal prediction mode information, division information, conversion coefficient information, and encoding cost information of the reference unit 1102 or the higher unit 1104.

The encoding apparatus 1100 may use the motion vector information of the reference unit 1102 or the higher unit 1104. The information collecting unit 1110 may collect the motion vector information of the reference unit 1102 or the higher unit 1104. Thereafter, when a motion vector based on the motion vector information of the reference unit 1102 or the higher unit 1104 is smaller than a particular value or when the motion vector of the higher unit 1104 is equal to a predictive motion vector obtained from the reference unit 1102, the predictive coding unit 1120 encodes the current coding unit or the current prediction unit in the skip mode and omit the remaining predictive coding process. Here, the particular value may include any one of 0, 1, and an average value of motion vector values of the reference units encoded in the skip mode.

The encoding apparatus 1100 may use optimal prediction mode information of the reference unit 1102 or the higher unit 1104. The information collecting unit 1110 collects optimal prediction mode information of the reference unit 1102 or the higher unit 1104. Thereafter, based on optimal prediction mode information of the reference unit 1102 or the higher unit 1104, when the optimal prediction mode information is any one of the skip mode or the merge mode, the predictive coding unit 1120 may encode the current coding unit or the current prediction unit in the skip mode or the merge mode and omit the remaining predictive coding process.

The encoding apparatus 1100 may use division information of the reference unit 1102. The information collecting unit 1110 collects division information of the reference unit 1102. Thereafter, based on division information of the reference unit 1102, when the size of the reference unit 1102 has not been divided or when the size of the reference unit 1102 is greater than that of the current coding unit, the predictive coding unit 1120 may encode the current coding unit or the current prediction unit, without dividing them, in the skip mode and omit the remaining predictive coding process.

The encoding apparatus 1100 may use encoding cost information of the reference unit 1102 or the higher unit 1104. The encoding cost may include at least one of rate-distortion cost, SAD value, SSE value, and SATD value. In using the encoding cost, the predictive coding unit 1120 may include an encoding cost calculation unit (not shown) for calculating encoding cost of the current coding unit or the current prediction unit and a prediction coding process omitting unit (not shown) for comparing calculated encoding cost with any one of average encoding cost of the reference units 1102 encoded in any one of the skip mode or the merge mode and encoding cost of the higher unit 1104 encoded in any one of the skip mode or the merge mode, and encoding the current coding unit or the current prediction unit in any one of the skip mode and the merge mode and omitting the remaining predictive coding process, when the calculated encoding cost is smaller.

The information collecting unit 1110 collects the encoding cost information of the reference unit 1102 or the higher unit 1104. The information collecting unit 1110 calculates average encoding cost of the reference units 1102 coded in any one of the skip mode and the merge mode and encoding cost of the unit having a greater size coded in any one of the skip mode and the merge mode.

Thereafter, a cost calculation (not shown) of the predictive coding unit 1120 calculates the encoding cost of the current coding unit or the current prediction unit. In calculating the encoding cost, preferably, it is assumed that the current coding unit or the current prediction unit has been encoded in any one of the skip mode and the merge mode.

The predictive coding process omitting unit (not shown) of the predictive coding unit 1120 compares the calculated encoding cost of the current coding unit or the current prediction unit with the average encoding cost of the reference units or the encoding cost of the higher unit. When the calculated encoding cost of the current coding unit or the current prediction unit is smaller than the average encoding cost of the reference units or the encoding cost of the higher unit, the current coding unit or the current prediction unit is highly likely to be encoded in the skip mode or the merge mode, so the predictive coding process omitting unit encodes the current coding unit or the current prediction unit in the skip mode or the merge mode and omits the remaining coding process. If the calculated encoding cost of the current coding unit or the current prediction unit is greater than the average encoding cost of the reference units or the encoding cost of the higher unit, the predictive coding process omitting unit cannot omit the coding process of the current coding unit or the current prediction unit, so it normally performs the predictive coding process.

According to another embodiment of the present invention, the information collecting unit 1110 calculates encoding cost of the reference unit 1102 and calculates average encoding cost of the units previously coded in the skip mode or the merge mode. When the encoding cost of the reference units is smaller than the average encoding cost of the units previously encoded in the skip mode or the merge mode, the predictive coding process omitting unit (not shown) of the predictive coding unit 1120 may encode the current coding unit or the current prediction unit in the skip mode and omit the remaining coding process.

Also, according to another embodiment of the present invention, when the encoding costs increase toward lower units, the predictive coding process omitting unit (not shown) may omit the coding process with respect to the lower units.

The encoding apparatus 1100 may use conversion coefficient information of the reference unit 1102. The information collecting unit 1110 collects conversion coefficient information of the reference unit 1102 or the higher unit 1104. Thereafter, based on the conversion coefficient information of the reference unit 1102 or the higher unit 1104, when anyone of the conversion coefficients of any one of the reference units 1102 and the higher units 1104 are entirely or mostly 0, the predictive coding unit 1120 may encode the current coding unit or the current prediction unit in the skip mode and omit the remaining predictive coding process.

In another embodiment of the present invention, the conversion coefficient information may include at least any one of the coded block pattern information and the coded block flag information.

According to the encoding method and apparatus according to embodiments of the present invention, since whether to omit the coding process with respect to a current coding unit or a coding unit having a smaller size in the reference coding unit or a coding unit having a greater size is determined by using statistical characteristics and coding information of an image, calculation complexity can be effectively reduced.

Also, according to the encoding method and apparatus according to embodiments of the present invention, since whether to omit coding is determined in consideration of a greater number of factors than that of the related art, such as depth information, conversion coefficient information, motion vector information, and the like, as well as an optimal prediction mode even in coding information, coding can be more accurately performed.

Also, according to the encoding method and apparatus according to embodiments of the present invention, in determining an optimal prediction mode with respect to a current coding unit or a prediction unit, an optimal prediction mode is quickly determined based on coding information of a reference unit and a higher unit, thus being advantageous in coding efficiency and a coding rate.

While the present invention has been shown and described in connection with the embodiments, it will be apparent to those skilled in the art that modifications and variations can be made without departing from the spirit and scope of the invention as defined by the appended claims.

What is claimed is:

1. An encoding method comprising:
an information collecting step of collecting at least any one of coding information of a reference unit, which includes at least one of a first reference unit that is positioned to be adjacent to a current coding unit or a current prediction unit and previously coded, a second reference unit present at a position corresponding to the current coding unit or the current prediction unit in a reference image, and a third reference unit positioned to be adjacent to the second reference unit, or coding information of a higher unit, which includes the current coding unit or the current prediction unit and has a size greater than that of the current coding unit or the current prediction unit; and
a predictive coding performing step of performing predictive coding by determining whether to omit a predictive coding process with respect to the current coding unit or the current prediction unit by using the collected coding information.

2. The method of claim 1, wherein the information collecting step includes a step of collecting at least any one of motion vector information of the reference unit or the higher unit, optimal prediction mode information, division information, conversion coefficient information, and encoding cost information.

3. The method of claim 2, wherein the predictive coding performing step includes:
encoding the current coding unit or the current prediction unit in a skip mode and omitting a remaining predictive coding process with respect to the current coding unit or the current prediction unit, either when a motion vector is smaller than a particular value based on at least any one motion vector information of the reference unit and the higher unit, or when a motion vector of the higher unit is equal to a predicted motion vector obtained from the reference unit.

4. The method of claim 2, wherein the predictive coding performing step includes:
encoding the current coding unit or the current prediction unit in the skip mode or a merge mode and omitting a remaining predictive coding process with respect to the current coding unit or the current prediction unit, when, based on at least any one of optimal prediction mode information of the reference unit and the higher unit, the optimal prediction mode information is any one of the skip mode and the merge mode.

5. The method of claim 2, wherein the predictive coding performing step includes:
encoding the current coding unit or the current prediction unit in the skip mode without dividing the current coding unit or the current prediction unit, and omitting a remaining predictive coding process with respect to the current coding unit or the current prediction unit, when, based on division information of the reference unit, the reference unit or the current prediction unit has not been divided or the size of the reference unit is greater than that of the current coding unit.

6. The method of claim 2, wherein the predictive coding performing step includes:
calculating encoding cost of the current coding unit or the current prediction unit; and comparing the calculated encoding cost with any one of an average encoding cost of reference units encoded in any one of the skip mode and the merge mode and encoding cost of a higher unit encoded in any one of the skip mode and the merge mode, and encoding the current coding unit or the current prediction unit in the skip mode or the merge mode and omitting a remaining predictive coding process with respect to the current coding unit or the current prediction unit when the calculated encoding cost is smaller.

7. The method of claim 2, wherein the predictive coding performing step includes:
when conversion coefficients of any one of the reference units and the higher units are entirely or mostly 0, encoding the current coding unit or the current prediction unit in the skip mode and omitting a remaining predictive coding process with respect to the current coding unit or the current prediction unit.

8. The method of claim 3, wherein the particular value includes any one of 0, 1, and an average value of motion vector values of reference units encoded in the skip mode.

9. The method of claim 6, wherein the encoding cost includes any one of rate-distortion cost, a sum of absolute difference (SAD) value, a sum of squared difference (SSD) value, and a sum of absolute transformed difference (SATD) value.

10. The method of claim 7, wherein the conversion coefficient includes at least one of coded block pattern information and coded block flag information.

11. An encoding apparatus comprising:
an information collecting unit configured to collect at least any one of coding information of a reference unit, which includes at least one of a first reference unit that is positioned to be adjacent to a current coding unit or a current prediction unit and previously coded, a second reference unit present at a position corresponding to the current coding unit or the current prediction unit in a reference image, and a third reference unit positioned to be adjacent to the second reference unit, or coding information of a higher unit, which includes the current coding unit or the current prediction unit and has a size greater than that of the current coding unit or the current prediction unit; and
a predictive coding unit configured to perform predictive coding by determining whether to omit a predictive coding process with respect to the current coding unit or the current prediction unit by using the collected coding information.

12. The apparatus of claim 11, wherein the information collecting unit collects at least any one of motion vector information of the reference unit or the higher unit, optimal prediction mode information, division information, conversion coefficient information, and encoding cost information.

13. The apparatus of claim 12, wherein either when a motion vector is smaller than a particular value based on at least any one motion vector information of the reference unit and the higher unit, or when a motion vector of the higher unit is equal to a predicted motion vector obtained from the reference unit, the predictive coding unit encodes the current coding unit or the current prediction unit in a skip mode and omits a remaining predictive coding process with respect to the current coding unit or the current prediction unit.

14. The apparatus of claim 12, wherein based on at least any one of optimal prediction mode information of the reference unit and the higher unit, when the optimal prediction mode information is any one of the skip mode and the merge mode, the predictive coding unit encodes the current coding unit or the current prediction unit in the skip mode or the merge mode and omits a remaining predictive coding process with respect to the current coding unit or the current prediction unit.

15. The apparatus of claim 12, wherein based on division information of the reference unit, when the reference unit or the current prediction unit has not been divided or the size of the reference unit is greater than that of the current coding unit, the predictive coding unit encodes the current coding unit or the current prediction unit in the skip mode without dividing the current coding unit or the current prediction unit, and omits a remaining predictive coding process with respect to the current coding unit or the current prediction unit.

16. The apparatus of claim 12, wherein the predictive coding unit comprises:
a cost calculation unit configured to calculate encoding cost of the current coding unit or the current prediction unit; and
a predictive encoding process omitting unit configured to compare the calculated encoding cost with any one of an average encoding cost of reference units encoded in any one of the skip mode and the merge mode and encoding cost of a higher unit encoded in any one of the skip mode and the merge mode, and encode the current coding unit or the current prediction unit in the skip mode or the merge mode and omit a remaining predictive coding process with respect to the current coding unit or the current prediction unit when the calculated encoding cost is smaller.

17. The apparatus of claim 12, wherein when conversion coefficients of any one of the reference units and the higher units are entirely or mostly 0, the predictive coding unit encodes the current coding unit or the current prediction unit in the skip mode and omits a remaining predictive coding process with respect to the current coding unit or the current prediction unit.

18. The apparatus of claim 13, wherein the particular value includes any one of 0, 1, and an average value of motion vector values of reference units encoded in the skip mode.

19. The apparatus of claim 16, wherein the encoding cost includes any one of rate-distortion cost, a sum of absolute difference (SAD) value, a sum of squared difference (SSD) value, and a sum of absolute transformed difference (SATD) value.

20. The apparatus of claim 17, wherein the conversion coefficient includes at least one of coded block pattern information and coded block flag information.
